(19) United States
(12) Patent Application Publication
(10) Pub. No.: US 2021/0195955 A1
(43) Pub. Date: Jul. 1, 2021

(54) COIL WINDING APPARATUS AND COIL WINDING METHOD

(71) Applicant: NITTOKU Co., Ltd., Saitama-city, Saitama (JP)

(72) Inventors: Nao SHIBUYA, Nagasaki-shi (JP); Yuji HIGETA, Nagasaki-shi (JP)

(73) Assignee: NITTOKU Co., Ltd., Saitama-city, Saitama (JP)

(21) Appl. No.: 17/273,507

(22) PCT Filed: Mar. 18, 2020
(86) PCT No.: PCT/JP2020/012077

§ 371 Date: Mar. 4, 2021

(30) Foreign Application Priority Data
Mar. 25, 2019 (JP) 2019-056010

(51) Int. Cl. A24F 40/46; A24F 40/70; B21C 47/02; B65H 54/02; H05B 3/46

(52) U.S. Cl. CPC A24F 40/46; A24F 40/70; H05B 3/46; B65H 54/02; B21C 47/02

(57) ABSTRACT

A coil winding apparatus includes: a cylindrical core rod nozzle configured to allow insertion of a narrowed core rod; a wire rod feeding unit configured to feeding a wire rod to the core rod nozzle; a wire rod holding tool configured to hold the wire rod fed from the wire rod feeding unit; a core rod winding unit configured to wind the wire rod drawn from the wire rod feeding unit by rotating the wire rod holding tool around the core rod nozzle; a core rod drawing unit configured to draw the core rod from the core rod nozzle; and a coil drawing unit configured to draw a wound wire formed by winding the wire rod on an outer periphery of the core rod nozzle from the core rod nozzle.

### TECHNICAL FIELD

The present invention relates to a coil winding apparatus and a coil winding method.

### BACKGROUND ART

Generally, there is a known heater element for an electronic cigarette that is formed by processing a wire rod made of a high resistivity alloy (for example, Nichrome, aldirom, constantan alloy, and so forth) into a predetermined shape (JP2016-507137A). With this heater element, a smoking effect is generated by atomizing a smoking liquid when energized. In order to atomize the smoking liquid efficiently, such a wire rod may be wound in a spiral manner around a core rod to be impregnated with the smoking liquid. According to such a heater element, the smoking liquid impregnated into the core rod may be efficiently atomized by the wire rod that is energized and heated.

### SUMMARY OF INVENTION

Because the wire rod used to form the heater element made of the high resistivity alloy needs to be processed to a predetermined shape, the wire rod has a flexibility, but also, it is relatively rigid. Because the smoking liquid needs to be impregnated, the core rod is often formed into a string shape by binding heat resistive fibers such as glass fibers. The core rod having the string shape formed by binding such fibers is relatively soft. Therefore, in the manufacture of the heater element, the relatively rigid wire rod is wound around the relatively soft string-shaped core rod in a spiral manner. Thus, mechanization of manufacturing steps of the heater element is difficult, and in reality, many steps are performed by manual operations.

An object of the present invention is to provide a coil winding apparatus and a coil winding method that are capable of winding a relatively rigid wire rod around a relatively soft string-shaped core rod in a spiral manner.

According to an aspect of the present invention, a coil winding apparatus includes: a cylindrical core rod nozzle having an outer diameter smaller than a natural outer diameter of a string-shaped core rod and configured to allow insertion of a narrowed core rod; a wire rod feeding unit configured to feeding a wire rod to the core rod nozzle; a wire rod holding tool configured to hold the wire rod fed from the wire rod feeding unit; a wire rod winding unit configured to wind the wire rod fed from the wire rod feeding unit around the core rod nozzle by rotating the wire rod holding tool around the core rod nozzle; a core rod drawing unit configured to draw the core rod from the core rod nozzle; and a coil drawing unit configured to draw a wound wire formed by winding the wire rod on an outer periphery of the core rod nozzle from the core rod nozzle.

According to another aspect of the present invention, a winding method for winding a wire rod around a string-shaped core rod spirally, the winding method includes: a winding step of winding the wire rod spirally around an outer periphery of a cylindrical core rod nozzle through which the core rod is inserted, to form a wound wire; and a transferring step of shifting the wound wire drawn from the core rod nozzle to an around of the core rod while drawing out the core rod from the core rod nozzle.

### BRIEF DESCRIPTION OF DRAWINGS

FIG. 1 is a plan view showing a coil winding apparatus of an embodiment according to the present invention.

FIG. 2 is a front view of the coil winding apparatus shown in FIG. 1.

FIG. 3 is a sectional view taken along a line III-III in FIG. 1 and shows a state in which a wire rod has been fed towards a core rod from the direction intersecting the core rod.

FIG. 4 is a sectional view taken along a line IV-IV in FIG. 1.

FIG. 5 is a sectional view taken along a line V-V in FIG. 2.

FIG. 6 is a sectional view corresponding to FIG. 4, showing a wire rod holding tool is open.

FIG. 7 is a perspective view showing a state in which the wire rod fed out from a wire rod nozzle is held by the wire rod holding tool.

FIG. 8 is a perspective view corresponding to FIG. 7, showing a condition in which the wire rod is wound helically around a core rod nozzle by rotating the wire rod holding tool and moving the wire rod nozzle.

FIG. 9 is a perspective view corresponding to FIG. 8, showing a state in which the core rod fed out from a core rod holding tool.

FIG. 10 is a perspective view corresponding to FIG. 9, showing a condition in which a wound wire is shifted around the core rod by moving the wire rod nozzle as well as moving the core rod holding device away from the core rod nozzle.

FIG. 11 is a perspective view corresponding to FIG. 10, showing a state of cutting the wire rod and the core rod after shifting the wound wire.

FIG. 12 is a perspective view of a coil in which the wound wire composed of a spirally wound the wire rod is provided around the core rod.

### DESCRIPTION OF EMBODIMENTS

Next, a coil winding apparatus and a coil winding method according to an embodiment of the present invention will be described with reference to the drawings.

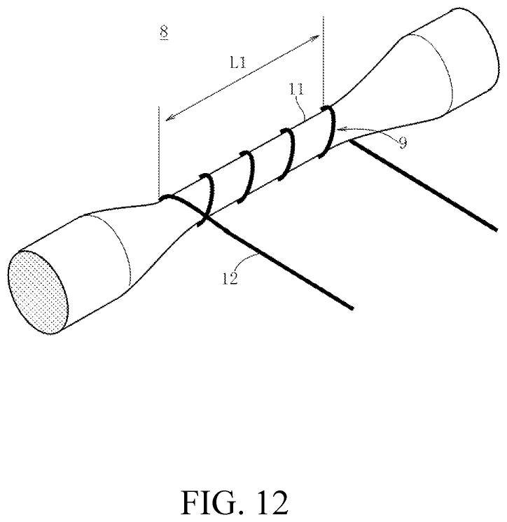

FIG. 12 shows a coil 8 obtained by the present embodiment. The coil 8 forms, for example, a heater element of an electronic cigarette. Specifically, the coil 8 includes a wound wire 9 formed by winding the wire rod 12 spirally, and a core rod 11 around which the wound wire 9 is provided. The core rod 11 in the present embodiment is a member that is formed into a string shape by binding a bundle of heat resistive fibers such as glass fibers. The wire rod 12 is, for example, a Nichrome wire made of a high resistivity alloy, and its rigidity is higher than the core rod 11.

In the heater element of the electronic cigarette, if there is a gap between the wire rod 12 and the core rod 11 or if the core rod 11 is squeezed too much, a liquid is not supplied around the wire rod 12 sufficiently. As a result, there is a possibility that the wire rod 12 is burned. For such a reason, it is required to wind the wire rod 12 in moderate close contact without gaps around the core rod 11. Further, a string-shaped core rod 11 composed of a bundle of fibers is soft and does not stabilize an outer diameter. When the outer diameter of the core rod 11 is varied, which has been formed by winding the wire rod 12 in moderate close contact without gaps around the core rod 11, is also varied. As the inner diameter of the spiral member (wound wire 9) is varied, a length of the wire rod 12 is also varied, and in turn, the electrical resistance is varied. Thus, it is important to control the inner diameter (an electrical resistance control) of the spiral member (wound wire 9). In the heater element of the electronic cigarette, the electrical resistance of the wire rod 12 is a factor that determines an amount and taste of a liquid smoke, and the electrical resistance control is extremely important.

According to the present embodiment, the relatively rigid wire rod 12 may be wound around the relatively soft string-shaped core rod 11 in a spiral manner. In addition, according to the present embodiment, the wire rod 12 may be wound around the core rod 11 at the same inner diameter in a spiral manner without forming a gap between the core rod 11 and the wire rod 12.

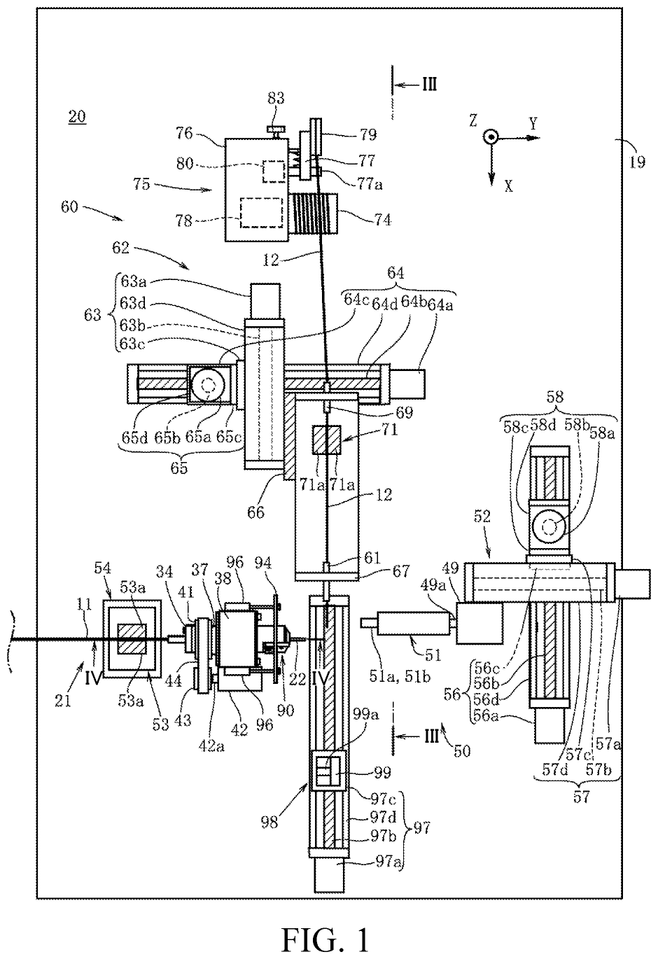

FIGS. 1 to 3 show a coil winding apparatus 20 according to the present embodiment. In the figures, the X axis, the Y axis and, the Z axis that are orthogonal to each other are set, and the configuration of the coil winding apparatus 20 will be described. The X axis is an axis extending in the substantially horizontal longitudinal direction, the Y axis is an axis extending in the substantially horizontal transverse direction, and the Z axis is an axis extending in the substantially vertical direction.

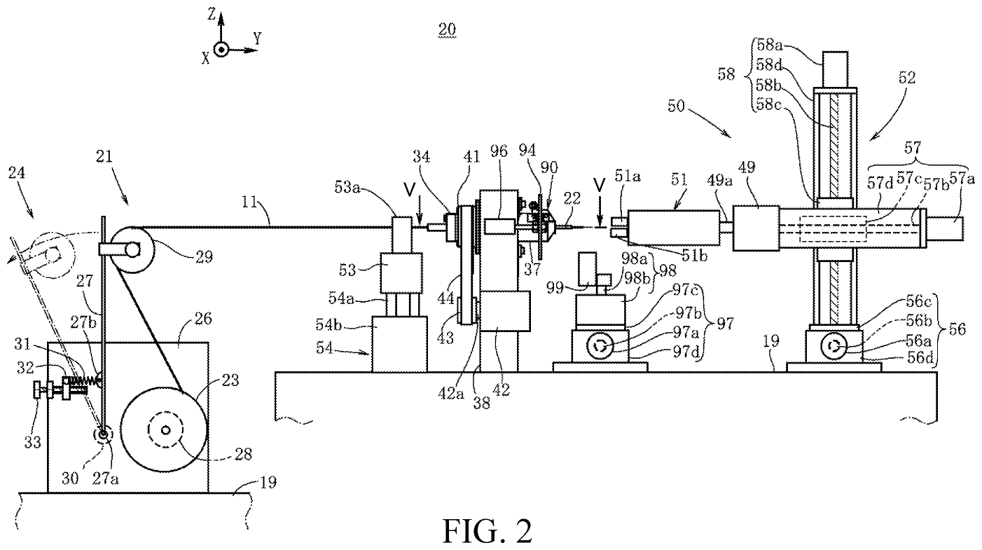

The coil winding apparatus 20 is provided with core rod feeding unit 21 that feeds the string-shaped core rod 11 made of a bundle of fibers through a core rod nozzle 22 at a constant tension. As shown in FIG. 2, the core rod 11 is stored by being wound on a core rod spool 23, and the core rod 11 is guided to the core rod nozzle 22 by being unwound from the core rod spool 23. A core rod tension device 24 for applying the constant tension to the core rod 11 is provided between the core rod spool 23 and the core rod nozzle 22.

The core rod tension device 24 is configured so as to be capable of applying the tension to the core rod 11 and pulling back the core rod 11. The core rod tension device 24 is provided with a casing 26 that is provided on a mounting 19 and a tension bar 27 that is provided on a side surface of the casing 26 in the X axis direction so as to extend along the side surface.

The core rod spool 23 is provided on the side surface of the casing 26 in the X axis direction. A feeding control motor 28 that rotates the core rod spool 23 to feed the core rod 11 is provided in the inside of the casing 26. A core rod guide pulley 29 is provided on a distal end of the tension bar 27. The core rod 11 is fed from the core rod spool 23 and guided to the core rod guide pulley 29, and thereby, the core rod 11 is wired from the core rod guide pulley 29 so as to be inserted through the core rod nozzle 22.

A turning shaft 27a that extends in the X axis direction is provided on a proximal end of the tension bar 27, and the tension bar 27 is configured so as to be able to turn about the turning shaft 27a. The turning angle of the turning shaft 27a is detected by a potentiometer 30 serving as turning angle detection means that is accommodated in the casing 26 and mounted to the turning shaft 27a. A detection output from the potentiometer 30 is input to a controller (not shown), and a control output from the controller is linked to the feeding control motor 28.

At a predetermined position between the turning shaft 27a of the tension bar 27 and the core rod guide pulley 29, a spring 31 that is an elastic member serving as biasing means is mounted at one end thereof via a mounting bracket 27b. The spring 31 biases the tension bar 27 towards the turning direction of the tension bar 27. The tension bar 27 receives an elastic force from the spring 31 correspondingly to the turning angle. Other end of the spring 31 is fixed to a moving member 32. The moving member 32 is screwed to a tension adjusting screw 33 and is configured such that the movement thereof can be adjusted in accordance with rotation of the tension adjusting screw 33. In other words, the position at which the other end of the spring 31 is fixed can be changed, and thereby, the tension of the core rod 11 that is applied by the tension bar 27 can be adjusted.

The controller (not shown) is configured so as to control the feeding control motor 28 such that the turning angle detected by the potentiometer 30 becomes a predetermined angle. Therefore, in the core rod tension device 24, the tension is applied to the core rod 11 by the spring 31 via the tension bar 27, and the core rod spool 23 is rotated such that the turning angle of the tension bar 27 becomes a predetermined angle, and thereby, the core rod 11 is fed out at a predetermined amount. Thus, the tension of the core rod 11 is maintained at a predetermined level.

As shown in FIG. 1 and FIG. 2, the core rod nozzle 22 is a cylindrical structure having an inner diameter through which the core rod 11 can pass. The core rod nozzle 22 is, for example, metallic and is hard compared to the core rod 11. The coil winding apparatus 20 has a rotator 37 in which the core rod nozzle 22 is provided insertably-removably. The rotator 37 rotates about the core rod nozzle 22. Specifically, the mounting 19 is erected a support pillar 38, the cylindrical rotator 37 is provided in the support pillar 38 through the Y-axis direction.

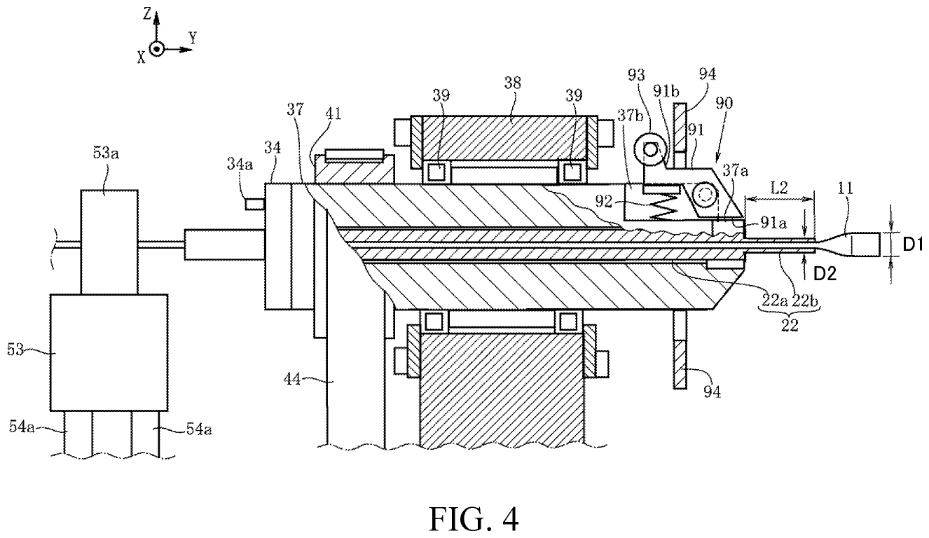

As shown in FIG. 4, the cylindrical core rod nozzle 22 is composed of an insertion a cylindrical member 22a, which is housed in the rotator 37, and the insertion cylindrical member 22a, which is contiguous to the insertion cylindrical member 22a and protrudes from the tip edge of the rotator 37. The outer diameter D2 of the wounding cylindrical member 22b is formed smaller than the natural outer diameter D1 of a string-shaped core rod 11 comprising a bundle of fibers, and the inner diameter of a wounding cylindrical member 22b is configured to allow insertion of the stretched and the narrowed core rod 11. The length L2 of the wounding cylindrical member 22b protruding from the leading edge of the rotator 37 is longer than the length L1 (FIG. 12) required for the wound wire 9 in the coil 8 to be obtained.

The core rod nozzle 22 is inserted into the rotator 37 from the core rod tension device 24 (FIG. 2) end. A fixing tool 34 is attached to the proximal end of the insertion cylindrical member 22a. The fixing tool 34 is attracted to the end of the rotator 37 by magnetic force. The fixing tool 34 is provided with an operation lever 34a which generates a magnetic force for attraction.

The core rod nozzle 22 is mounted through the fixing tool 34. The fixing tool 34 contacts the end of the rotator 37 with the core rod nozzle 22 inserted on the central axis of the rotator 37. When the operating lever 34a is operated with the fixing tool 34 contacting the end of the rotator 37, the magnetic force is generated, the fixing tool 34 is attracted to the end of the rotator 37. Therefore, the core rod nozzle 22 provided the fixing tool 34 is fixed to the rotator 37.

In this way, the core rod nozzle 22 is inserted into the cylindrical rotator 37 on a central axis of the rotator 37. The rotator 37 is provided in the support pillar 38 via a bearing 39 to allow rotation around the core rod nozzle 22. The core rod nozzle 22 is attached to the rotator 37 via the fixing tool 34 and is rotatable with the rotator 37.

As shown in FIGS. 1 and 2, the coil winding apparatus 20 is provided with a core rod drawing unit 50 that holds and draws out the core rod 11 that has been inserted through the core rod nozzle 22 from the core rod nozzle 22. The core rod drawing unit 50 in the present embodiment is provided with a core rod holding device 51 that is configured such that a pair of clamping blocks 51a and 51b are opened and closed by a fluid pressure and the core rod 11 can be held by the clamping blocks 51a and 51b, a motor 49 that rotates the core rod holding device 51 about the core rod 11 that has been held, and a core-rod-holding-device moving mechanism 52 that is capable of moving the core rod holding device 51, together with the motor 49, in three axial directions.

The core-rod-holding-device moving mechanism 52 illustrated in FIGS. 1 and 2 is configured by combining X axis, Y axis, and Z axis direction telescopic actuators 56 to 58. In other words, the telescopic actuators 56 to 58 have, respectively, elongated box-shaped housings 56d to 58d, ball screws 56b to 58b that are provided so as to extend in the housings 56d to 58d in the lengthwise directions and that are respectively rotationally driven by servo motors 56a to 58a, and followers 56c to 58c that are respectively screwed to the ball screws 56b to 58b and undergo translation movement.

In the present embodiment, the core rod holding device 51 is mounted to a rotating shaft 49a of the motor 49, the motor 49 is mounted to the housing 57d of the Y axis direction telescopic actuator 57 so as to be able to move the core rod holding device 51 in the Y axis direction, and the follower 57c of the Y axis direction telescopic actuator 57 is mounted to the follower 58c of the Z axis direction telescopic actuator 58 so as to be able to move, together with the Y axis direction telescopic actuator 57, the core rod holding device 51 in the Z axis direction. Further, the housing 58d of the Z axis direction telescopic actuator 58 is mounted to the follower 56c of the X axis direction telescopic actuator 56 so as to be able to move, together with the Y axis and Z axis direction telescopic actuators 57 and 58, the core rod holding device 51 in the X axis direction. The housing 56d of the X axis direction telescopic actuator 56 is fixed to the mounting 19 so as to extend in the X axis direction.

The servo motors 56a to 58a in the telescopic actuators 56 to 58 are connected to a controller (not shown), and they are controlled by the controller. In other words, with the telescopic actuators 56 to 58, as the servo motors 56a to 58a are driven by commands from the controller (not shown), the ball screws 56b to 58b are rotated, and thereby, the followers 56c to 58c screwed to the ball screws 56b to 58b are moved along the lengthwise direction of the housings 56d to 58d. As the followers 56c to 58c are moved, the core rod holding device 51 is moved in three axial directions.

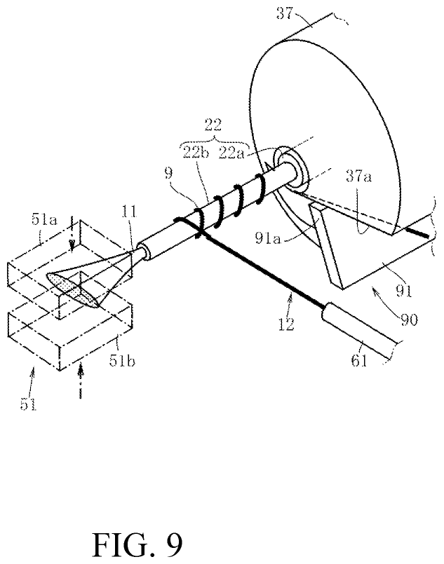

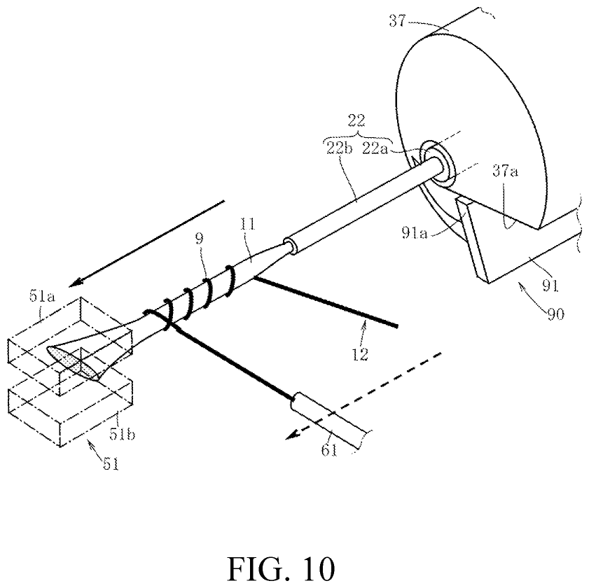

The core rod holding device 51 with the pair of opening clamping blocks 51a and 51b is moved such that the core rod 11 projecting from a distal end of the core rod nozzle 22 is positioned between the pair of clamping blocks 51a and 51b, and thereafter, as described in FIG. 9, the pair of clamping blocks 51a and 51b are closed to hold the core rod 11 with the pair of clamping blocks 51a and 51b. In addition, by moving the core rod holding device 51 in the direction away from the core rod nozzle 22 while holding the core rod 11, as described in FIG. 10, the core rod 11 is drawn out from the core rod nozzle 22. As described above, the core rod drawing unit 50 is configured so as to hold the core rod 11 inserted into the core rod nozzle 22 and draw the core rod 11 out from the core rod nozzle 22.

As described in FIGS. 1 and 2, a core rod clamping tool 53 is provided on the mounting 19. In the core rod clamping tool 53, the core rod 11 extending from the core rod tension device 24 to the core rod nozzle 22 is clamped by clamping blocks 53a at the vicinity of the first support pillar 36, thereby prohibiting the movement of the core rod 11 towards the core rod nozzle 22.

The core rod clamping tool 53 shown in FIG. 2 is a so-called fluid pressure cylinder. Specifically, in the core rod clamping tool 53, the pair of clamping blocks 53a are moved so as to be separated away from each other or so as to come closer with each other by using fluid pressure. By moving the pair of clamping blocks 53a so as to come closer with each other in a state in which the core rod 11 is passed through between the separated pair of clamping blocks 53a, the core rod 11 is claimed. In the core rod clamping tool 53, a main body 54b is mounted to an upper end of a retracting shaft 54a of a fluid pressure cylinder 54 that is provided on the mounting 19 such that the retracting shaft 54a is orientated vertically. The fluid pressure cylinder 54 lowers the core rod clamping tool 53 that is not clamping the core rod 11. Thereby, the core rod clamping tool 53 is moved to a position where routing of the core rod 11 is not interfered.

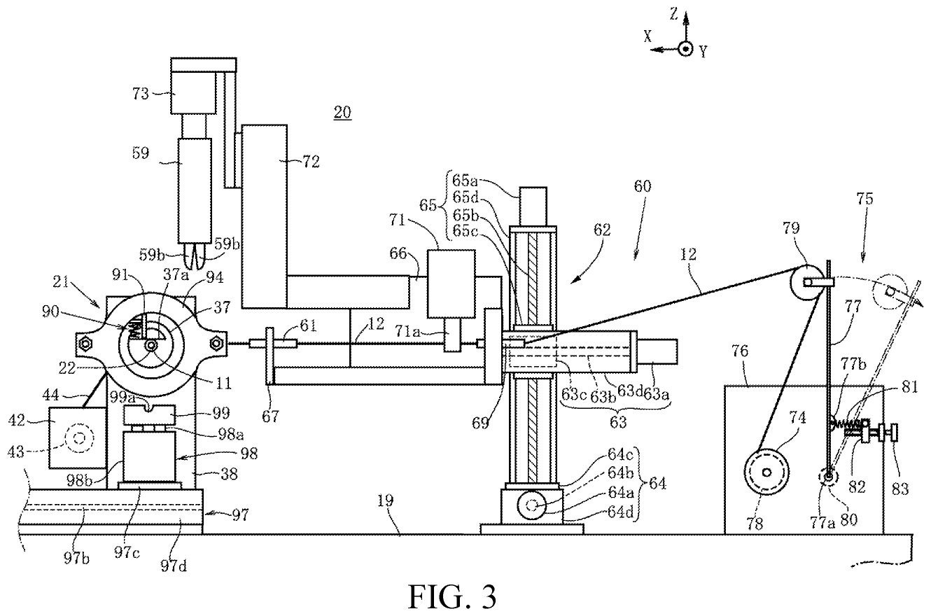

As shown in FIGS. 1 and 3, the coil winding apparatus 20 is provided with a wire rod feeding unit 60 that feeds the wire rod 12 to the core rod nozzle 22 from a direction orthogonal to the core rod nozzle 22. The wire rod feeding unit 60 is provided with a wire rod nozzle 61 through which the wire rod 12 is inserted and a wire-rod-nozzle moving mechanism 62 that moves the wire rod nozzle 61 in the three axial directions.

The wire-rod-nozzle moving mechanism 62 is configured so as to be capable of moving a support plate 66 in the three axial directions with respect to the mounting 19. The wire-rod-nozzle moving mechanism 62 has the same structure with that of the above-described core-rod-holding-device moving mechanism 52. Specifically, the wire-rod-nozzle moving mechanism 62 is provided with an X axis direction telescopic actuator 63 that moves the support plate 66 in the X axis direction, a Z axis direction telescopic actuator 65 that moves, together with the X axis direction telescopic actuator 63, the support plate 66 in the Z axis direction, and a Y axis direction telescopic actuator 64 that moves, together with the X axis and the Z axis direction telescopic actuator 63 and 65, the support plate 66 in the Y axis direction.

The support plate 66 is mounted to a housing 63d of the X axis direction telescopic actuator 63. A follower 63c of the X axis direction telescopic actuator 63 is mounted to a follower 65c of the Z axis direction telescopic actuator 65. A housing 65d of the Z axis direction telescopic actuator 65 is mounted to a follower 64c of the Y axis direction telescopic actuator 64. A housing 64d of the Y axis direction telescopic actuator 64 is fixed to the mounting 19 so as to extend in the Y axis direction. Servo motors 63a to 65a in the telescopic actuators 63 to 65 are connected to a controller (not shown) that controls these components. The servo motors 63a to 65a respectively rotate ball screws 63b to 65b of the telescopic actuators 63 to 65.

The wire rod nozzle 61 is fixed to the mounting plate 67. The support plate 66 supports the mounting plate 67 so that the wire rod nozzle 61 faces the X-axis. The support plate 66 supports a proximal end nozzle 69 located coaxially with the wire rod nozzle 61 and a wire rod clamping tool 71 located near proximal end nozzle 69. The wire rod clamping tool 71 releasably clamps the wire rod 12 passing through the proximal end nozzle 69 and towards the wire rod nozzle 61 by a pair of clamping blocks 71a. A detailed explanation of the wire rod clamping tool 71 will be omitted since the same structural fluid pressure cylinder with the core rod clamping tool 53 for clamping the core rod 11 as the wire rod clamping tool 71 is used.

Similarly to the core rod 11, the wire rod 12 is stored by being wound on a wire rod spool 74. The wire rod 12 that is unwound and fed from the wire rod spool 74 is inserted through the proximal end nozzle 69 and the wire rod nozzle 61 in this order. The coil winding apparatus 20 is provided with a wire rod tension device 75 that applies a predetermined tension to the wire rod 12 that has been unwound from the wire rod spool 74.

The wire rod tension device 75 in the present embodiment has substantially the same structure as the structure of the core rod tension device 24 (see FIG. 2) that applies a predetermined tension to the core rod 11. In other words, the wire rod tension device 75 is provided with a casing 76 that is provided on the mounting 19 and a tension bar 77 that is provided on a side surface of the casing 76 in the Y axis direction so as to extend along the side surface. The wire rod spool 74 is provided on the side surface of the casing 76. A feeding control motor 78 that rotates the wire rod spool 74 is provided in an interior of the casing 76. A wire rod guide pulley 79 is provided on a distal end of the tension bar 77. A rotating shaft 77a is provided on a proximal end of the tension bar 77, and a potentiometer 80 that detects the turning angle of the rotating shaft 77a is provided in the casing 76.

As shown in FIG. 3, one end of a spring 81 is mounted on the tension bar 77 via a mounting bracket 77b. Other end of the spring 81 is fixed to a moving member 82. The moving member 82 is screwed to a tension adjusting screw 83 and is configured such that the movement thereof can be adjusted in accordance with rotation of the tension adjusting screw 83.

In other words, in the wire rod tension device 75, the tension is applied to the wire rod 12 by the spring 81 via the tension bar 77. In addition, the wire rod spool 74 is rotated by controlling the feeding control motor 78 such that the tension bar 77 is oriented in a predetermined angle, in other words, such that the turning angle detected by the potentiometer 80 becomes a predetermined angle, and the wire rod 12 is fed at a predetermined amount. Thereby, the tension of the wire rod 12 is maintained at a predetermined level.

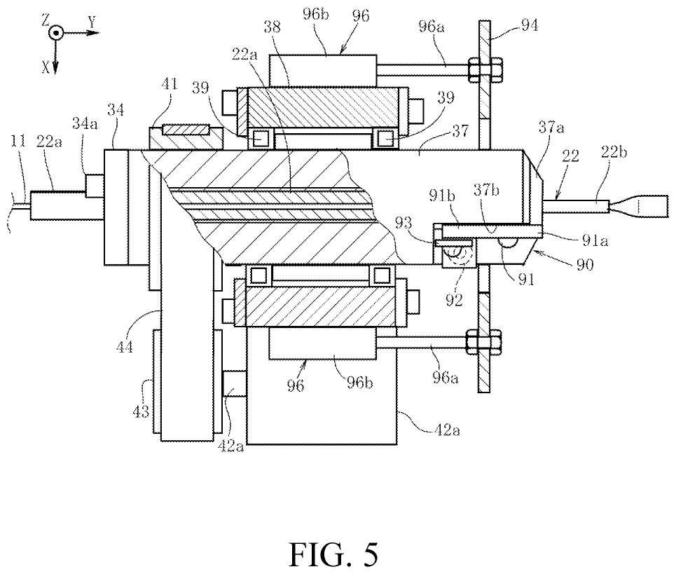

As shown in FIG. 1, in the rotator 37 where the core rod nozzle 22 is inserted, a wire rod holding tool 90 for holding wire rod 12 fed out from the core rod feeding unit 60 is provided. As shown in FIG. 4 and FIG. 5, the wire rod holding tool 90 includes a placing member 37a formed in the rotator 37 and a clamping block 91 for holding the wire rod 12 with the placing member 37a.

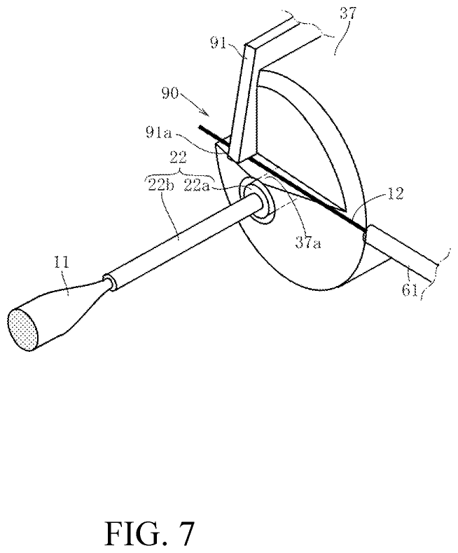

Specifically, a part of the distal end in the rotator 37 is tapered so that the center protrudes the most, and the wounding cylindrical member 22b in the core rod nozzle 22 protrudes from the end surface of the rotator 37. Another part of the distal end in the rotator 37 is formed so that the conical shape is cut straight in the unwinding direction of the wire rod 12, that is, in the cross direction of the central axis of the rotator 37. As shown in FIG. 7, the placing member 37a for placing the wire rod 12 extending straight from the wire rod nozzle 61 is formed by a notch.

As shown in FIG. 4 and FIG. 5, in the distal end portion of the rotator 37, notches to form a vertical wall 37b parallel to the core rod nozzle 22 and perpendicular to the placing member 37a is further formed. On the vertical wall 37b, the clamping block 91 for clamping the wire rod 12 with the placing member 37a is pivotally supported. The clamping block 91 is a plate member formed in a substantially V-shape. The approximate center of the clamping block 91 is pivoted. A tip portion 91a of the clamping block 91 is the part clamping the wire rod 12 with the placing member 37a. Between a base end portion 91b of the clamping block 91 and the rotator 37, a spring 92 as a biasing member for biasing so as to press the tip portion 91a against the placing member 37a is provided. The spring 92 is specifically a coil spring.

A roller 93 is pivotally supported on the base end portion 91b of the clamping block 91. Around the rotator 37, an annular plate member 94 which can abut against the roller 93 is provided coaxially with the rotator 37. As shown in FIG. 5, on the support pillar 38 for supporting the rotator 37, a pair of fluid pressure cylinders 96 for movably supporting the plate member 94 in the Y-axis direction is attached. The pair of fluid pressure cylinders 96 are placed to space from each other in the X-axis direction, the support pillar 38 is provided between the pair of fluid pressure cylinders 96. An each of main body portions 96b of the fluid pressure cylinders 96 is mounted with a retracting shaft 96a of the support pillar 38 toward the Y-axis. The plate member 94 is attached to the protruding end of the retracting shaft 96a.

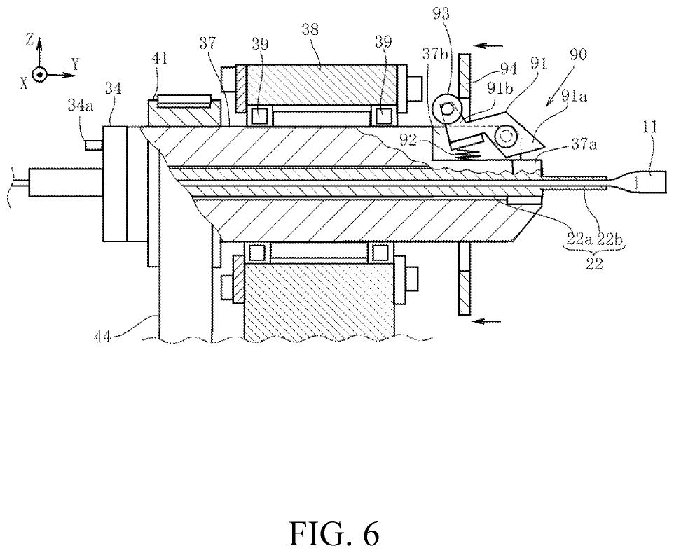

The plate member 94 contacts the roller 93 when the retracting shafts 96a of the fluid pressure cylinders 96 are sunk in the main body portions 96b respectively to bring the plate member 94 close to the support pillar 38. Further moving the plate member 94, as shown in FIG. 6, the plate member 94 pushes the roller 93 against the biasing force of the spring 92 to bring the roller 93 close to the rotator 37. Consequently, the clamping block 91 rotates and the tip portion 91a is spaced from the placing member 37a. In this condition, between the tip portion 91a and the placing member 37a, the wire rod 12 is accessible and the wire rod 12 is removable from between the tip portion 91a and the placing member 37a.

When the retracting shaft 96a of the fluid pressure cylinder 96 sticks out from the main body portion 96b, the plate member 94 moves away from the support pillar 38 and is spaced from the roller 93. As shown in FIG. 4, the biasing force of the spring 92, the tip portion 91a of the clamping block 91 is pressed against the placing member 37a. When the tip portion 91a is pressed against the placing member 37a with the wire rod 12 disposed between the tip portion 91a and the placing member 37a, the wire rod 12 is clamped by the tip portion 91a and the placing member 37a of the clamping block 91. In this way, the wire rod holding tool 90 including the clamping block 91 is configured to clamp the wire rod 12 or to break off the clamping thereof, by the movement of the plate member 94.

As shown in FIG. 1 and FIG. 2, the rotator 37 protrudes from the support pillar 38 toward the core rod tension device 24. The protruding end of the rotator 37 is fitted with a pulley 41. The support pillar 38 is provided with a motor 42 as a rotating means for rotating the rotator 37 together with the wire rod holding tool 90. The motor 42 has a rotating shaft 42a parallel to the rotator 37. The rotating shaft 42a of the motor 42, a pulley 43 separate from the pulley 41 is provided. The motor 42 may be provided on the mounting 19.

A belt 44 is multiplied between the pulley 41 of the rotator 37 and the pulley 43 of the rotating shaft 42a at motor 42. When the motor 42 is driven, the rotation of the rotating shaft 42a is transmitted to the rotator 37 via the belt 44, and the rotator 37 is rotated.

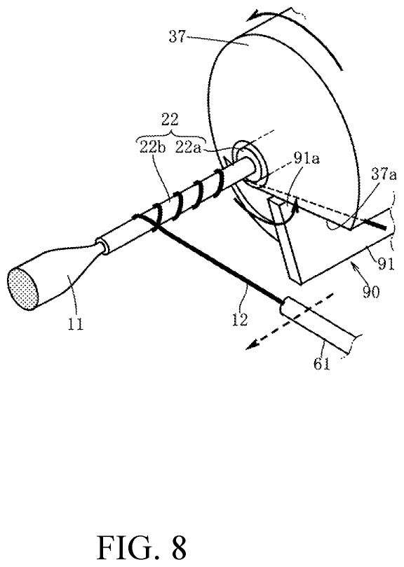

The wire rod holding tool 90 rotates with the wire rod 12, as shown in FIG. 8, when the motor 42 as a rotating means rotates the rotator 37 while the wire rod holding tool 90 holds. The wire rod 12 extending to the wire rod holding tool 90 from the wire rod nozzle 61 is wound guided around the core rod nozzle 22 that protrudes from the leading edge of the rotator 37, that is, is wound guided around the cylindrical member 22b. In other words, the motor 42 is a core rod winding means that causes the wire rod holding tool 90 to rotate the wire rod holding tool 90 around the core rod nozzle 22 to wind the wire rod 12 that is drawn out of the core rod feeding unit 60 around the core rod nozzle 22.

As shown in FIG. 3, in addition to the wire rod clamping tool 71, the support plate 66 supports a cutter device 59. The cutter device 59 uses air pressure to cut the wire rod 12 that has passed through the wire rod nozzle 61 and the core rod 11 that has passed through the core rod nozzle 22. The cutter device 59 is mounted on a rotating cylinder 73, the rotating cylinder 73 is mounted on an elevating cylinder 72, and the elevating cylinder 72 is mounted on the support plate 66. The elevating cylinder 72 is driven by a command from a controller (not shown) to move the rotating cylinder 73 and the cutter device 59 up and down. The rotating cylinder 73 rotates the cutter device 59 about the vertical axis.

The cutter device 59 is lowered by the elevating cylinder 72, and thereby, cutter blades 59b are moved to cutting positions for cutting the wire rod 12 and the core rod 11. In addition, the cutter device 59 is lifted by the elevating cylinder 72, and thereby, the cutter blades 59b are moved to a stand-by position away from the wire rod 12 and the core rod 11. The cutter device 59 is rotated by the rotating cylinder 73 about the vertical axis, and thereby, the cutter device 59 is switched from a wire rod cutting orientation in which the cutter blades 59b pinch and cut the wire rod 12 to a core rod cutting orientation in which the cutter blades 59b pinch and cut the core rod 11 extending orthogonal to the wire rod 12.

As shown in FIGS. 1 to 3, a receiving tool 99 is provided under the feeding-side end portion of the core rod nozzle 22. The receiving tool 99 receives the coil 8 that is formed by winding the wire rod 12 around the core rod 11 in a spiral manner. The receiving tool 99 is mounted on a fluid pressure cylinder 98, and the fluid pressure cylinder 99 is mounted on a follower 97c of an telescopic actuator 97. A housing 97d of the telescopic actuator 97 is mounted on the mounting 19 so as to extend in the X axis direction.

A main body 98b of the fluid pressure cylinder 98 is mounted on the follower 97c of the telescopic actuator 97 such that an retracting shaft 98a of the fluid pressure cylinder 98 faces upwards. The receiving tool 99 is mounted on an upper end of the retracting shaft 98a of the fluid pressure cylinder 98. A recessed groove 99a capable of receiving the coil 8 (see FIG. 12) is formed on a top portion of the receiving tool 99 so as to be in parallel with the feeding direction of the core rod 11. In a state in which the coil 8 is received in the recessed groove 99a, the receiving tool 99 is lowered by the fluid pressure cylinder 98 and is further moved in the X axis direction by the telescopic actuator 97, and thereby, the coil 8 thus obtained can be taken out to the outside.

Next, a coil winding method of the present invention will be described.

In the coil winding method of the present invention, the wire rod 12 is spirally wound around the string-shaped core rod 11. The coil winding method is characterized in that it has a winding step in which the wire rod 12 is spirally wound around an outer periphery of the cylindrical core rod nozzle 22 through which the core rod nozzle 11 is inserted, and a transferring step in which the wound wire 9 formed by winding the wire rod 12 around a periphery of the core rod nozzle 22 is drawing out of the core rod nozzle 22 and displaced around the core rod 11.

The coil winding method is performed on the above-described coil winding apparatus 20. A procedure of the coil winding method will be described specifically. In the present invention, before the winding step, a preparation step is performed. In the preparation step, first, the core rod 11 and the wire rod 12 are attached to the coil winding apparatus 20. As shown in FIG. 2, the core rod 11, which is wound and stored on the core rod spool 23, is prepared, and the core rod spool 23 is mounted on the side surface of the casing 26 in the core rod tension device 24 such that the feeding control motor 28 can rotate the core rod spool 23. The core rod 11 that has been unwound from the core rod spool 23 is guided to the core rod guide pulley 29 of the distal end of the tension bar 27 and inserted through the core rod nozzle 22.

The core rod nozzle 22 in the present embodiment is a straight cylindrical member that has the inner diameter smaller than the outer diameter of the core rod 11 in the natural state. The core rod 11 is inserted through the core rod nozzle 22 in a state in which the core rod 11 is stretched such that the outer diameter thereof is reduced suitably. In addition, core rod 11 is drawn from the core rod nozzle 22 for the required length.

The operation of inserting the core rod 11 into the core rod nozzle 22 can also be performed on the core rod nozzle 22 in the condition of inserting the rotator 37 and being attracted to the rotator 37 by the fixing tool 34. The core rod 11 may be inserted into the core rod nozzle 22 in state of its drawn out from the rotator 37, and then the core rod nozzle 22 may be inserted into the rotator 37, and attached to the rotator 37 via the fixing tool 34.

With the core rod 11 inserted into the core rod nozzle 22, the core rod clamping tool 53 provided in mounting 19 makes the core rod clamping tool 53 clamp the core rod 11, thereby prohibiting the movement of the core rod 11. This prevents the core rod 11 from being pulled back from the core rod nozzle 22 even if the core rod tension device 24 pulls the core rod 11.

As shown in FIG. 3, the wire rod 12 that has been wound and stored on the wire rod spool 74 is prepared, and the wire rod spool 74 is mounted on the side surface of the casing 76 of the wire rod tension device 75 such that the feeding control motor 78 can rotate the wire rod spool 74. The wire rod 12 that has been unwound from the wire rod spool 74 is guided to the wire rod guide pulley 79 on the distal end of the tension bar 77 and is inserted through the proximal end nozzle 69 and the wire rod nozzle 61 in this order.

The protrusion of the wire rod 12 from the wire rod nozzle 61 is set to a length that exceeds the length required for the drawer of the coil 8 (FIG. 12) to be obtained. After the wire rod 12 that exceeds the required length is drawn out of the wire rod nozzle 61, the wire rod 12 is clamped by the wire rod clamping tool 71 provided on the support plate 66 to prevent the wire rod 12 from moving. This prevents the wire rod 12 from being pulled from the wire rod nozzle 61 even if the wire rod 12 is pulled to the wire rod tension device 75 side by the wire rod tension device 75.

After that, the winding step is started. In case of using the coil winding apparatus 20, in the winding step, a wire rod holding step which the wire rod 12 drawn out from wire rod nozzle 61 is held by the wire rod holding tool 90, and a holding tool rotation step while the wire rod holding tool 90 holding the wire rod 12 is rotated around the core rod nozzle 22, the wire rod nozzle 61 is moved along the core rod nozzle 22 are performed.

In the wire rod holding step, the wire rod 12 is held by wire rod holding tool 90. First, the motor 42 as a rotating means is driven to rotate the rotator 37 so that the placing member 37a formed at the tip of the rotator 37 is parallel to the unwinding direction of the wire rod 12, as shown in FIG. 7.

The retracting shaft 96a of the fluid pressure cylinder 96 (FIG. 5) in the wire rod holding tool 90 provided in the rotator 37 is sunk in the main body portion 96b. By doing this, as shown in FIG. 6, the roller 93 approaches the rotator 37 against the biasing force of the spring 92, the tip portion 91a at the clamping block 91 is spaced from the placing member 37a.

The wire rod nozzle 61 is then moved by the wire-rod-nozzle moving mechanism 62 (FIG. 1 and FIG. 3). As shown in FIG. 7, the wire rod 12 being fed from the wire rod nozzle 61 is placed on the placing member 37a formed at the end of the rotator 37 to position the wire rod 12 between the placing member 37a and the tip portion 91a in the clamping block 91.

After inserting the wire rod 12 between the tip portion 91a of the clamping block 91 and the placing member 37a, the retracting shaft 96a of the fluid pressure cylinder 96 shown in FIG. 5 is made to protrude to separate the plate member 94 from the roller 93. By doing this, as shown in FIG. 4, the biasing force of the spring 92 presses the tip portion 91a of the clamping block 91 against the placing member 37a and the wire rod 12 is held by the tip portion 91a and the placing member 37a.

Thereafter, when the clamping of the wire rod 12 by the wire rod clamping tool 71 provided in the support plate 66 (FIG. 1 and FIG. 3) is broken off, the drawing of the wire rod 12 is allowed. The wire rod 12 does not pull back from the wire rod nozzle 61 even if the wire rod tension device 75 pulls the wire rod 12, because the wire rod 12 fed out from the wire rod nozzle 61 is held by the wire rod holding tool 90.

Next, the holding tool rotation step is performed. In the a holding tool rotation step, as shown in FIG. 8, the wire rod nozzle 61 is moved in parallel with the core rod nozzle 22 as indicated by the broken line arrow, while the wire rod holding tool 90 holding the wore rod 12 unwounded from the wire rod nozzle 61 is rotated around the core rod nozzle 22 as indicated by the solid line arrow. By doing this, the outer periphery of the cylindrical core rod nozzle 22 through which core rod 11 is inserted, the wire rod 12 is wound in a spiral shape.

As shown in FIG. 8, the wire rod holding tool 90 is provided in the rotator 37 where the core rod nozzle 22 is inserted on the central axis. Therefore, by driving the driving motor 42 (FIG. 2) as a rotating means and rotating the rotator 37 with a required number of times, it is possible to rotate the wire rod holding tool 90 about the core rod nozzle 22.

The wire rod nozzle 61 is moved by the wire-rod-nozzle moving mechanism 62 (FIG. 1 and FIG. 3). When the wire rod nozzle 61 is moved in parallel with the core rod nozzle 22 while the wire rod holding tool 90 is rotated around the core rod nozzle 22, the wire rod 12, which is drawn out from the wire rod nozzle 61 in sequence, is spirally wound around the wounding cylindrical member 22b on the core rod nozzle 22.

The cylindrical core rod nozzle 22 is a member through which the core rod 11 is inserted, it is hard as compared with the core rod 11 if metallic. Therefore, even if the core rod 11 is soft, it is possible to wind a relatively hard the wire rod 12 around the core rod nozzle 22.

In this embodiment, the core rod nozzle 22 is attached to the rotator 37. Therefore, when the rotator 37 is rotated, the core rod nozzle 22 also rotates with the wire rod holding tool 90 provided in the rotator 37.

The rotating the wire rod holding tool 90 together with core rod nozzle 22, it is possible to avoid that such as being rubbed the wire rod 12 and the wound wire 9 formed by winding the wire rod 12 on the core rod nozzle 22 each other. And it is possible to prevent the surface-damage of the wire rod 12 due to rubbing.

After winding the wire rod 12 around spirally the wounding cylindrical member 22b of the core rod nozzle 22 a predetermined number of times, the rotation of the rotator 37 is stopped. The wire rod 12 is held again by the wire rod clamping tool 71 to prohibit the drawing of the new wire rod 12 from the wire rod nozzle 61. Then, the holding of wire rod 12 by the wire rod holding tool 90 is broken off. In this state, a transferring step is performed which is a next step.

In the transferring step, while feeding out the core rod 11 from the core rod nozzle 22, the wound wire 9 formed by winding the wire rod 12 around the outer periphery of the core rod nozzle 22 is drawn out from the core rod nozzle 22.

In the present embodiment, the core rod 11 is fed out by moving away the core rod holding device 51 holding the core rod 11 drawn out from the core rod nozzle 22.

That is, first, with the pair of clamping blocks 51a and 51b spaced from each other, the core-rod-holding-device moving mechanism 52 (FIG. 1 and FIG. 2) moves the core rod holding device 51 toward the position of facing to the tip of the core rod nozzles 22, the core rod 11 is positioned between the pair of clamping blocks 51a and 51b. After that, as shown in FIG. 9, the pair of clamping blocks 51a and 51b are brought close to each other, and the core rod 11 protruding from the tip edge of the core rod nozzles 22 is clamped by the pair of clamping blocks 51a and 51b.

When the clamping of the wire rod 12 by the core rod clamping tool 53 provided on the mounting 19 (FIG. 1 and FIG. 3) is broken off, the drawing of the wire rod 12 is allowed. The core rod 11 does not pull back from the core rod nozzle 22 even if the core rod tension device 24 pulls the core rod 11, because the core rod 11 fed out from the core rod nozzle 22 is held by the core rod holding device 51 on the core rod drawing unit 50.

The core-rod-holding-device moving mechanism 52 is then driven to space the core rod holding device 51 holding the core rod 11 from the core rod nozzle 22. This causes the core rod 11 to be drawn from the core rod nozzle 22 as indicated by the solid line arrows in FIG. 10.

Together with the drawing out of the core rod 11, the wound wire 9 formed by winding the wire rod 12 around the core rod nozzle 22 spirally is drawn from the core rod nozzle 22. Specifically, the wire-rod-nozzle moving mechanism 62 (FIG. 1 and FIG. 3) moves the wire rod nozzle 61 that draws the wire rod 12 that is continuous with the wound wire 9 together with the wound wire 9 in parallel to the core rod nozzle 22 and in the same direction at the same speed as drawing of the core rod 11, by doing so, the wound wire 9 is drawn out from the core rod nozzle 22. That is, the wire-rod-nozzle moving mechanism 62 is a coil drawing means for drawing the wound wire 9 formed by winding the wire rod 12 around on the outer periphery of core rod nozzle 22 from the core rod nozzle 22.

When the wire rod 12 is wound around the core rod nozzle 22, the wire rod 12 is maintained in a spiral shape by plastic deformation. When the rotation of the wire rod holding tool 90 around the core rod nozzle 22 is stopped and the holding of the wire rod 12 by the wire rod holding tool 90 is broken off, the wound wire 9, which was formed by winding the wire rod 12 in a spiral pattern, loosens back slightly in the opposite direction due to the remaining elasticity. As a result, a gap is created between the outer periphery of core rod nozzle 22 and the wound wire 9.

Therefore, the wound wire 9 successive the wire rod nozzle 61, by moving parallel to the longitudinal direction of the core rod nozzle 22, it is possible that the loosed core rod nozzle 22 is drawn out and shift to the periphery of core rod 11 to be drawn.

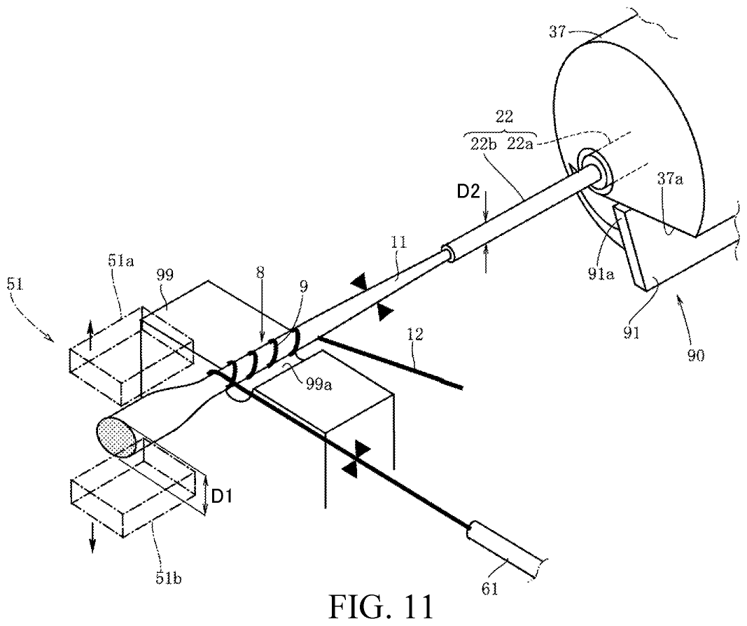

As shown in FIG. 11, the wound wire 9 is withdrawn from the core rod nozzle 22 and the required length of the core rod 11 is further drawn from the core rod clamping tool 53 (FIG. 1 and FIG. 2) provided in front of the core rod nozzle 22 to hold the core rod 11. Thus, the subsequent drawing out of the core rod 11 is prohibited. In this condition, the hold of the core rod 11 by the core rod holding device 51 in the core rod drawing unit 50 is broken off. Consequently, the force that stretches core rod 11 disappears.

The inner diameter of the wound wire 9 formed by winding the wire rod 12 on the wounding cylindrical member 22b is larger than the inner diameter of the core rod nozzle 22. Therefore, with the wound wire 9 formed by winding the wire rod 12 shifted around the periphery of the core rod 11 fed out of the core rod nozzle 22, when the force that stretches the core rod 11 disappears, the core rod 11 transitions to a natural state and the outer diameter of the core rod 11 increases. Therefore, the core rod 11 does not become excessively bound.

Here, the outer diameter D2 of the wounding cylindrical member 22b of the core rod nozzle 22 where the wire rod 12 is wound is smaller than the outer diameter D1 of the natural condition of the core rod 11. Therefore, the inner diameter of the wound wire 9 formed by winding the wire rod 12 on the wounding cylindrical member 22b is smaller than the outer diameter D1 of the natural condition of the core rod 11.

Therefore, the wound wire 9 formed by winding the wire rod 12 on the core rod nozzle 22 is moderately in close contact with the outer peripheral surface of the core rod 11 where the outer diameter is enlarged. Therefore, the wire rod 12 at the same inner diameter around the core rod 11 is in a state of being wound helically. Thus, in this embodiment, the relatively hard wire rod 12 can be spirally wound around the relatively soft string-like core rod 11.

After the winding is completed, by moving the cutter device 59 shown in FIG. 3 to the cutting position by the elevating cylinder 72, cutting the wire rod 12 as shown in FIG. 11. Next, the direction of the cutter device 59 is changed by the rotating cylinder 73 and moved by the wire-rod-nozzle moving mechanism 62. The wire rod 12 is spirally wound the core rod 11 is cut at a predetermined length to obtain the coil 8 shown in FIG. 12 wound helically around the core rod 11.

In addition, as described in FIG. 11, when the core rod 11 is cut, it is preferable that the coil 8 shown in FIG. 12, in which the wire rod 12 is wound around the core rod 11 in a spiral manner, be received in the recessed groove 99a in the receiving tool 99 by positioning the receiving tool 99 under the core rod 11 and by lifting the receiving tool 99 by the fluid pressure cylinder 98.

Once the core rod 11 is cut, the coil 8 shown in FIG. 12, in which the wire rod 12 is wound around the core rod 11 in a spiral manner, is supported by the receiving tool 99 independently. A series of winding operation is finished by removing the coil 8 by moving the receiving tool 99 in the X axis direction from underneath the core rod nozzle 22 by the telescopic actuator 97, and the next winding operation is started. By doing so, it is possible to consecutively obtain the coil 8 shown in FIG. 12, in which the wire rod 12 is wound around the core rod 11 in a spiral manner.

In the above-mentioned embodiment, descriptions have been given on the core-rod-holding-device moving mechanism 52 and the wire-rod-nozzle moving mechanism 62 that are configured by combining the X axis, the Y axis, and the Z axis direction telescopic actuators. However, the structures of the core-rod-holding-device moving mechanism 52 and the wire-rod-nozzle moving mechanism 62 are not limited thereto, and other structures may also be employed as long as the core rod holding device 51, the wire rod nozzle 61, and so forth can be moved in the three axial directions with respect to the mounting 19.

In addition, in the above-mentioned embodiment, descriptions have been given on a case in which the tension bars 27 and 77 are tilted by the springs 31 and 81, respectively, and thereby, the tension is applied to the core rod 11 and the wire rod 12 by the core rod tension device 24 and the wire rod tension device 75, respectively. However, the structures of the core rod tension device 24 and the wire rod tension device 75 are not limited those described above, and other structures may also be employed. For example, the core rod tension device 24 and the wire rod tension device 75 may have structures in which the tension may be applied to the core rod 11 and/or the wire rod 12 by moving the core rod spool 23 and/or the wire rod spool 74 themselves/itself.

Furthermore, in the above embodiment, it is described that the core rod nozzle 22 is inserted in the rotator provided with the wire rod holding tool 90, and is attached to the rotator 37, and the core rod nozzle 22 together with the wire rod holding tool 90 is rotated integrally. Not limited to above, in the present invention, it is not necessary that the core rod nozzle 22 is rotated together with the wire rod holding tool 90, as long as the wire rod 12 is wound around the core rod nozzle 22 spirally without occurring damage of the wire rod 12. That is, it may be possible that only the wire rod holding tool 90 is rotated around the core rod nozzle 22 while the core rod nozzle 22 is stationary.

Furthermore, in the above embodiment, the fixing tool 34 is attracted to the end of the rotator 37 by a magnetic force, to fix the core rod nozzle 22 to the rotator 37. It may be possible that the fixing tool 34 is configured to detachably attach the core rod nozzle 22 to rotator 37 using a force other than the magnetic force. For example, fixing tool 34 may be a mounting device using electrical power or may be a mechanical mounting device.

Furthermore, in the above embodiment, the wire rod holding tool 90 is configured to hold the wire rod 12 by means of a placing member 37a formed in the rotator 37 and the clamping blocks 91, and the circular plate member 94 operates the wire rod holding tool 90. The wire rod holding tool 90 is not limited to this embodiment, but may be in any other embodiment, as long as it can hold the wire rod 12, which is drawn out of the core rod feeding unit 60.

Furthermore, in the above embodiment, the core rod nozzle 22 has the insertion cylindrical member 22a which is housed in the rotator 37 and the wounding cylindrical member 22b which protrude from the leaning edge of the rotator 37 in continuity with insertion cylindrical member 22a. As long as the outer diameter of the portion of the wire rod 12 that is spirally wound is less than the natural outer diameter D1 of the core rod 11, the core rod nozzle 22 may be formed in a cylindrical shape having the same outer diameter.

Furthermore, In the above embodiment, the coil drawing unit comprises a wire-rod-nozzle moving mechanism 62 that moves the wire rod nozzle 61 in the drawing direction of the core rod nozzle 11. The coil drawing unit is not limited to this, but may be in any other form as long as the wound wire 9 formed by winding the wire 12 around the outer periphery of the core rod nozzle 22 is drawn from the core rod nozzle 22.

Furthermore, in the above-mentioned embodiment, a description has been given on a case in which the core rod 11 is drawn out in straight. However, if required, during the drawing of the core rod 11, it may be possible to draw out the core rod 11 while twisting it by rotating the core rod holding device 51 holding the core rod 11 by the motor 49.

As in the above embodiment, when core rod nozzle 22 is rotated together with the wire rod holding tool 90 when the wire rod 12 is wound, the core rod 11, which inserts the core rod nozzle 22, may be twisted. In this case, the twist of the core rod 11 can be eliminated by rotating the core rod holding device 51 by the motor 49 and drawing out the core rod 11 so that the core rod 11 twists in the opposite direction. Further, the wire rod 12 can be spirally wound around the core rod 11 without twisting with the same inner diameter. If twisting of the core rod 11 is not necessary, the motor 49 does not have to be installed.

The configurations, operations, and effects of the embodiments of the present invention will be collectively described below.

The coil winding apparatus is provided with: the cylindrical core rod nozzle having the outer diameter smaller than the natural outer diameter of the string-shaped core rod and configured to allow insertion of the narrowed core rod; the core rod feeding unit configured to feeding the wire rod to the core rod nozzle; the wire rod holding tool configured to hold the wire rod fed from the wire rod feeding unit; the core rod winding unit configured to wind the wire rod fed from the wire rod feeding unit around the core rod nozzle by rotating the wire rod holding tool around the core rod nozzle; the core rod drawing unit configured to draw the core rod from the core rod nozzle; and the coil drawing unit configured to draw the wound wire formed by winding the wire rod on the outer periphery of the core rod nozzle from the core rod nozzle.

When the coil winding apparatus is provided with the rotator which the core rod nozzle is inserted and the wire rod holding tool is provided in the shifted position in the tip portion of the rotator, it is preferable to rotate the rotator together with the wire rod holding tool around the core rod nozzle. And when the core rod nozzle is provided in the rotator insertably-removably, it is preferable to provide the core rod nozzle with the fixing tool configured to fix the core rod nozzle to the rotator by inserting the core rod nozzle into the rotator.

Furthermore, the core rod drawing unit may include the core rod holding device configured to hold the core rod fed from the core rod nozzle and the core rod-holding-device moving mechanism configured to move the core rod holding device. And when the core rod feeding unit is provided with the wire rod nozzle configured to feed the wire rod, it is preferable that the coil drawing unit is provided with the nozzle moving mechanism configured to move the wire rod nozzle to the drawing direction of the core rod.

The present coil winding method spirally wound a wire rod around a string-shaped core rod

The coil winding method includes the winding step that the wound wire is formed by winding the wire rod spirally around the outer periphery of the cylindrical core rod nozzle which the core rod is inserted, and a transferring step that the wound wire is drawn from the core rod nozzle and is shifted to the around of the core rod while the core rod is drawn from the core rod nozzle.

In the winding step, the wire rod is fed from the wire rod nozzle, and it is preferable to spirally wind the wire rod around the outer periphery of the core rod nozzle by moving the wire rod nozzle along the core rod nozzle while the wire rod holding tool that holds the wire rod fed from the wire rod nozzle is rotated around the core rod nozzle. The core rod nozzle may be rotated together with the wire rod holding tool.

In the transferring step, it is preferable that the wound wire is drawn from the core rod nozzle by moving the wire rod nozzle together with the wound wire in parallel with the core rod nozzle. Furthermore, it is preferable to draw the core rod by moving the core rod holding device that holds the core rod fed from the core rod nozzle in a direction away from the core rod nozzle.

In the coil winding apparatus and the coil winding method of this embodiment, the relatively hard wire rod can be wound by using a core rod nozzle that has relatively high hardness because the wire rod is wound around the core rod nozzle. And since the outer diameter of the core rod nozzle is uniform, the wire rod wound around the core rod nozzle make it possible to obtain the wound wire with an approximately uniform inner diameter.

After obtaining the wound wire having a substantially uniform inner diameter, by shifting the wound wire to the periphery of the core rod, it is possible to obtain the coil comprising the wound wire having a substantially uniform inner diameter made of a relatively hard wire rod and the core rod placed inside wound wire, even if core rod is soft.

Since the core rod nozzle drawn out the core rod has the outer diameter smaller than the outer diameter of the natural state of the core rod, the inner diameter of the wire rod formed by winding the wound wire on the outer periphery of core rod nozzle is smaller than the outer diameter of the natural state of the core rod. When the core rod is drawn from the core rod nozzle and the tension on the core rod disappears, the core rod transitions into the natural state and the outer diameter of the core rod is enlarged. As a result, the outer surface of the core rod with an enlarged outside diameter is in close contact with the inside of the wound wire which is transferred around the core rod in a small outside diameter. Therefore, the core rod does not become excessively bound, it is possible to obtain the coil in which the wire rod is wound spirally around the core rod with the same inner diameter.

Although the embodiments of the present invention have been described in the above, the above-mentioned embodiments merely illustrate a part of application examples of the present invention, and the technical scope of the present invention is not intended to be limited to the specific configurations of the above-described embodiments.

This application claims priority based on Japanese Patent Application No. 2019-56010 filed with the Japan Patent Office on Mar. 25, 2019, the entire contents of which are incorporated into this specification by reference.

1. A coil winding apparatus comprising:
a cylindrical core rod nozzle having an outer diameter smaller than a natural outer diameter of a string-shaped core rod and configured to allow insertion of a narrowed core rod;
a wire rod feeding unit configured to feed a wire rod to the core rod nozzle;
a wire rod holding tool configured to hold the wire rod fed from the wire rod feeding unit;
a wire rod winding unit configured to wind the wire rod fed from the wire rod feeding unit around the core rod nozzle by rotating the wire rod holding tool around the core rod nozzle;
a core rod drawing unit configured to draw the core rod from the core rod nozzle; and
a coil drawing unit configured to draw a wound wire formed by winding the wire rod on an outer periphery of the core rod nozzle from the core rod nozzle.

2. The coil winding apparatus according to claim 1, further comprising,
a rotator into which the core rod nozzle is inserted and in a tip portion of which the wire rod holding tool is provided in a shifted position, wherein
the core rod winding unit rotates the rotator together with the wire rod holding tool around the core rod nozzle.

3. The coil winding apparatus according to claim 2, wherein
the core rod nozzle is provided in the rotator insertably-removably,
the core rod nozzle is provided with a fixing tool configured to fix the core rod nozzle to the rotator with the core rod nozzle inserted on the rotator.

4. The coil winding apparatus according to claim 1, wherein
the core rod drawing unit includes a core rod holding device configured to hold the core rod fed from the core rod nozzle and a core rod-holding-device moving unit configured to move the core rod holding device.

5. The coil winding apparatus according to claim 1, wherein
the wire rod feeding unit includes a wire rod nozzle configured to feed the wire rod,
the coil drawing unit includes a nozzle moving unit configured to move the wire rod nozzle to drawing direction.

6. A winding method for winding a wire rod around a string-shaped core rod spirally, the winding method comprising:
a winding step of winding the wire rod spirally around an outer periphery of a cylindrical core rod nozzle through which the core rod is inserted, to form a wound wire; and
a transferring step of shifting the wound wire drawn from the core rod nozzle to an around of the core rod while drawing out the core rod from the core rod nozzle.

7. The coil winding method according to claim 6, comprising,
in the winding step, feeding the wire rod from the wire rod nozzle and winding the wire rod around spirally on the outer periphery of the core rod nozzle by moving the wire rod nozzle along the core rod nozzle while rotating a wire rod holding tool holding the wire rod fed from the wire rod nozzle around the core rod nozzle.

8. The coil winding method according to claim 7, comprising,
in the winding step, rotating the core rod nozzle together with the wire rod holding tool.

9. The coil winding method according to claim 7, comprising,
in the transferring step, drawing out the wound wire from the core rod nozzle by moving the wire rod nozzle together with the wound wire in parallel with the core rod nozzle.

10. The coil winding method according to claim 6, comprising,
in the transferring step, drawing the core rod by moving a core rod holding device that holds the core rod fed from the core rod nozzle in a direction away from the core rod nozzle.
